(19) United States
(12) Patent Application Publication
(10) Pub. No.: US 2008/0083891 A1
(43) Pub. Date: Apr. 10, 2008

(54) Gate Valve Actuator

(75) Inventor: David Holliday, Spring, TX (US)

Correspondence Address: Baker Botts L.L.P.;One Shell Plaza, Attn: Paul R. Morico, 910 Louisiana Street, Houston, TX, 77002-4995, US

(73) Assignee: Dril-Quip, Inc., Houston, TX (US)

(21) Appl. No.: 11/865,416

(22) Filed: Oct. 1, 2007

Related U.S. Application Data
(60) Provisional application No. 60/828,184, filed on Oct. 4, 2006.

(51) Int. Cl. F16K 3/02; F16K 31/122

(52) U.S. Cl. 251/63.6

(57) ABSTRACT

A gate valve actuator including an housing, a piston, a lower end closure, and a piston cylinder end cap. The piston is situated within the housing, and the lower end closure connects the housing and the piston. The piston cylinder end cap also connects the housing and the piston. The housing, the piston, the lower end closure, and the end cap define a main actuator cavity. The connection between the lower end closure and the piston and the connection between the piston cylinder end cap and the piston are sealable connections. The main actuator cavity is substantially isolated from ambient air and from a control fluid, which prevents moisture build-up and hence prevents corrosion of the internal components of the actuator.

### CROSS REFERENCE TO RELATED APPLICATION

This application claims the benefit of U.S. Provisional Application No. 60/828,184 filed on Oct. 4, 2006.

### BACKGROUND

Hydrocarbons, such as oil and gas are produced at a wellhead and conveyed through flow lines to remote gathering stations. Safety valves are conventionally used to automatically shut off flow upon the occurrence of some triggering event, such as unacceptable fluctuations in liquid level or pressure or temperature, or an electrical power loss. Additionally, safety valves may shut off flow when a catastrophic failure occurs due to explosion, storm damage, and the like.

Examples of typical safety valves include gate valves with hydraulic actuators, such as those disclosed in U.S. Pat. Nos. 4,744,386 and 4,836,243, which are hereby incorporated by reference.

Conventional valves with hydraulic actuators have a housing cavity, with a housing cavity volume that changes as the actuator strokes. To allow for this change in volume, without undesirable pressure change, the housing cavity is generally vented to the surrounding environment. Therefore, as the actuator strokes, ambient air moves into and out of the actuator housing. This movement of ambient air into and out of the actuator can introduce moisture, salt spray, or other contaminants into the actuator housing. This can cause a number of problems. For example, moist air within the actuator housing may condense out on the inside of the actuator, for example, when the actuator cools at night. As the actuator strokes, more and more condensate may accumulate inside of the actuator. Condensate may corrode the actuator's components. In some cases, the corrosion inside the actuator may be severe. Additionally, condensate may cause the visual position sight glass to become “fogged” over, such that the position indicator cannot be seen at all. In cold environments, condensate may freeze, preventing the actuator from working properly.

### SUMMARY

The present invention relates generally to valve actuators. More specifically, the present invention relates to gate valve actuators for use with hydraulic gate valves.

In one embodiment of the present invention, the gate valve actuator includes a housing, a piston, a lower end closure, and a piston cylinder end cap. The piston is situated within the housing, and the lower end closure connects the housing and the piston. The piston cylinder end cap also connects the outer housing and the piston. The connections between the lower end closure and the piston and between the piston cylinder end cap and the piston are sealable connections. The housing, the piston, the lower end closure, and the piston cylinder end cap define a main actuator cavity. The main actuator cavity is substantially isolated from ambient air and a control fluid that applies pressure to the piston, and the main actuator cavity will remain at a substantially constant volume.

In another embodiment of the present invention, the gate valve actuator includes a housing, a piston, a lower end closure, and a piston cylinder end cap. The piston is situated within the housing, and the lower end closure connects the housing and the piston. The piston cylinder end cap also connects the outer housing and the piston. The connections between the lower end closure and the piston and between the piston cylinder end cap and the piston are sealable connections. The housing, the piston, the lower end closure, and the end cap define a main actuator cavity. The main actuator cavity is substantially isolated from ambient air and a control fluid. The piston is capable of stroking along an axis parallel to the axis defined by the piston's connections to the lower end closure and the piston cylinder end cap. The volume of the main actuator cavity will remain substantially constant as the piston strokes.

In one embodiment of the present invention, the gate valve actuator includes a housing, a piston, a lower end closure, and a piston cylinder end cap. The gate valve actuator also includes a stem, a downstop, and a bonnet. The piston is situated within the housing, and the lower end closure connects the housing and the piston. The piston cylinder end cap also connects the outer housing and the piston. The connections between the lower end closure and the piston and between the piston cylinder end cap and the piston are sealable connections. The stem is situated within the housing below the lower end closure and extends along the same axis as the piston. The stem is connected to the lower terminus of the piston, and has a different diameter than the piston. The downstop connects the stem and a portion of the housing which is below the housing's connection to the lower end closure. The bonnet connects the housing to a valve body. The housing, the piston, the lower end closure, and the end cap define a main actuator cavity. The lower end closure, the stem, the downstop, the housing, and the bonnet define an inner cavity. The piston and the stem are capable of stroking along an axis parallel to the axis defined by the piston's connections to the lower end closure and the piston cylinder end cap. The main actuator cavity is substantially isolated from ambient air and a control fluid, and the main actuator cavity will remain at a substantially constant volume as the piston strokes. The volume of the inner cavity will change as the piston strokes relative to the inner cavity.

### BRIEF DESCRIPTION OF THE DRAWINGS

The following figures form part of the present specification and are included to demonstrate certain aspects of the present invention. The present invention may be better understood by reference to one or more of these drawings in combination with the description of embodiments presented herein.

Consequently, a more complete understanding of the present disclosure and advantages thereof may be acquired by referring to the following description taken in conjunction with the accompanying drawings, in which the leftmost significant digit(s) in the reference numerals denote(s) the first figure in which the respective reference numerals appear.

FIG. 1 is a partially cutaway side view of one embodiment of an actuator in accordance with the present invention.

FIG. 2 is a partially cutaway side view showing another embodiment according to the present invention.

FIG. 3 is a partially cutaway side view showing yet another embodiment according to the present invention.

FIG. 4 is a partially cutaway side view showing still another embodiment according to the present invention.

### DETAILED DESCRIPTION

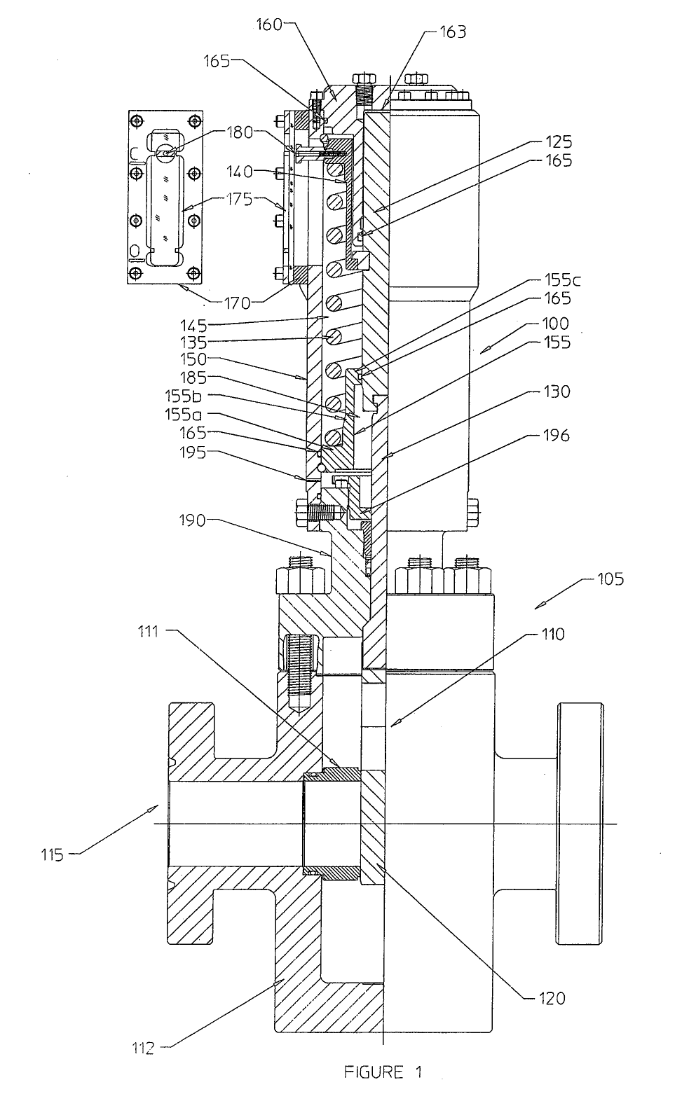

Referring now to FIG. 1, shown therein is a fail-safe gate valve actuator 100, attached to a gate valve 105 in accordance with one embodiment of the present invention. The actuator 100 of FIG. 1 causes the valve 105 to close upon the occurrence of any triggering event, such as, but not limited to, power failure, pressure rise, pressure drop, temperature rise, or temperature drop. Alternatively, in some circumstances it may be desirable that the actuator 100 cause the valve 105 to open upon the occurrence of any triggering event.

When the valve 105 is in an open position (not shown), a gate opening 110 aligns with a seat 111 in a valve body 112. The seat 111 is in fluid communication with a flow line 115, such that when the valve 105 is open, fluid passes therethrough. In a closed position, the gate opening 110 is positioned away from the flow line 115, and a gate 120 blocks the flow line 115. The gate 120 is connected to a piston 125 via a stem 130. The piston 125 may be moved to or held in the open position (in the embodiment shown in FIG. 1, the “down” position), with control pressure, such as hydraulic, pneumatic, or other pressure from a control fluid, applied to the piston cavity 163. The piston 125 may be moved to or held in the closed position (in the embodiment shown in FIG. 1, the “up” position), with a spring 135 acting upon a thrust ring 140 affixed to the piston 125. The thrust ring 140 may be affixed to the piston at a location on the piston that is disposed between the piston's connection to the piston cylinder end cap 160 and the piston's connection to the lower end closure 155. The thrust ring 140 may be moveable and loaded by the spring 135. The spring 135 will shift the piston 125 to the “up” position when hydraulic fluid is released from the actuator 100. The bottom of the spring 135 rests on a stationary lower end closure 155.

The lower end closure 155 may be of unitary construction, having a lower lip 155a, an elongated portion 155b, and an upper lip 155c. The upper lip 155c may extend substantially radially outward from the piston 125 to the elongated portion 155b. The elongated portion 155b may extend from the upper lip 155c, substantially parallel to the piston 125, to the lower lip 155a. The lower lip 155a may extend substantially radially outward from the elongated portion 155b to a housing 150 of the actuator 100. While unitary construction is disclosed and shown, the lower end closure 155 may be constructed in any of a number of ways.

The thrust ring 140 and the spring 135 may be positioned within a main actuator cavity 145. The main actuator cavity 145 may be defined by the piston 125, the housing 150 of the actuator 100, the lower end closure 155, and a piston cylinder end cap 160. The piston 125 may lie within the housing 150. The piston cylinder end cap 160 may connect the piston 125 and the housing 150 at a first latitude of the housing 150. The lower end closure 155 may connect the piston 125 and the housing 150 at a second, lower latitude of the housing 150. The connections between the piston 125 and the piston cylinder end cap 160 and between the piston 125 and the lower end closure 155 may be slidable sealable connections so that a seal is maintained as the piston 125 strokes and slides along the relatively stationary piston cylinder end cap 160 and the lower end closure 155. While the piston 125 may move relative to the main actuator cavity 145, the volume of the main actuator cavity 145 will remain substantially constant. This volume remains substantially constant because the piston 125 has a substantially uniform diameter, at least through the portion defining the main actuator cavity 145. Thus, as the piston 125 strokes, the volume of the piston 125 entering the main actuator cavity 145 is the same as the volume of the piston 125 exiting the main actuator cavity 145.

Seals 165 may isolate the main actuator cavity 145, preventing the introduction of a control fluid or air having moisture or other potential contaminants into the main actuator cavity 145. The seals 165 may be any type of seal known to one having ordinary skill in the art. For example, but not by way of limitation, the seals 165 may be made of a resilient material, such as an elastomer or a thermoplastic. The seal may also be made of a non-resilient material that is mechanically energized, such as a spring energized thermoplastic seal. Seals 165 also desirably maintain a liquid tight seal with the piston cavity 163 and the main actuator cavity 145. The seals 165 desirably maintain a substantially airtight seal between the main actuator cavity 145 and the ambient air, preventing weepage into or out of the actuator cavity 145. The seals 165 may form a hermetic seal. The seals 165 may be placed at a number of different locations at or near the boundary of the main actuator cavity 145. For example, seals 165 may be placed between the lower end closure 155 and the piston 125, between the piston 125 and the end cap 160, between the end cap 160 and the housing 150, and between the housing 150 and the lower end closure 155. While seals 165 are shown at these locations, seals 165 are not required at all of these locations. For example, the lower end closure 155 could be fixedly attached to the housing 150, and other boundary connections may be made in a similar fashion. The seals 165 may be factory installed.

As the piston 125 moves up or down, the seals 165 between the piston 125 and the end cap 160 and between the piston 125 and the lower end closure 155 minimize the passage of control fluid and/or air into or out of the main actuator cavity 145. This keeps the spring 135, the thrust ring 140, and other components in the main actuator cavity 145 free from excessive exposure to moisture, salt spray, and other contaminants, which can hinder the operation of the components. The air within the main actuator cavity 145 may also be purged with a gas, such as nitrogen, in order to further eliminate moisture from the inside of the actuator 100.

The housing 150 may include a sight glass housing 170 with a sight glass 175. The sight glass 175 allows the position of the piston 125 to be observed externally, and thereby provides a means to determine the position of the gate 120. An indicator 180 may attach to the thrust ring 140, such that the indicator 180 indicates the position of the thrust ring 140, and thus, the piston 125. When the main actuator cavity 145 is substantially isolated from contaminants, the surface of the sight glass 175 that faces the main actuator cavity 145 will remain clear, allowing for accurate readings of the piston position as indicated by indicator 180.

In addition to the main actuator cavity 145, the actuator 100 is formed with an inner cavity 185. The inner cavity 185 may be smaller than the main actuator cavity 145. The interior wall of the inner cavity 185 is defined by the piston 125 and the stem 130. The exterior wall of the inner cavity 185 is defined by a bonnet 190 connecting the housing 150 to the valve body 112 and a portion of the housing 150 just above the bonnet 190. An intermediate wall of the inner cavity 185 is defined by the lower end closure 155 and a downstop 196. The upper lip 155c of the lower end closure 155 and a lower lip of the downstop 196 define the upper and lower bounds of the inner cavity 185. When the piston 125 moves relative to the inner cavity 185, the volume of the inner cavity 185 changes. This volume changes because the piston 125 and the stem 130 have different diameters.

The inner cavity 185 may have a vent 195. The vent 195 allows air to enter or exit the inner cavity 185 as the piston 125 moves. The vent 195 is located in the housing 150. Since the components located in the inner cavity 185 would not be significantly affected by moisture or other contaminants, the introduction of ambient air into the inner cavity 185 would not significantly impair the performance of the actuator 100. While the vent 195 is desirable, it is not necessary. Instead of being vented, the air within the inner cavity 185 may experience a pressure change.

The downstop 196 stops the piston 125 from moving the stem 130, and thus the gate opening 110 beyond the seat 111. Thus, the downstop 196 may cause proper alignment of the gate 120 for flow of fluid through the flow line 115 when the valve 105 is in the open position.

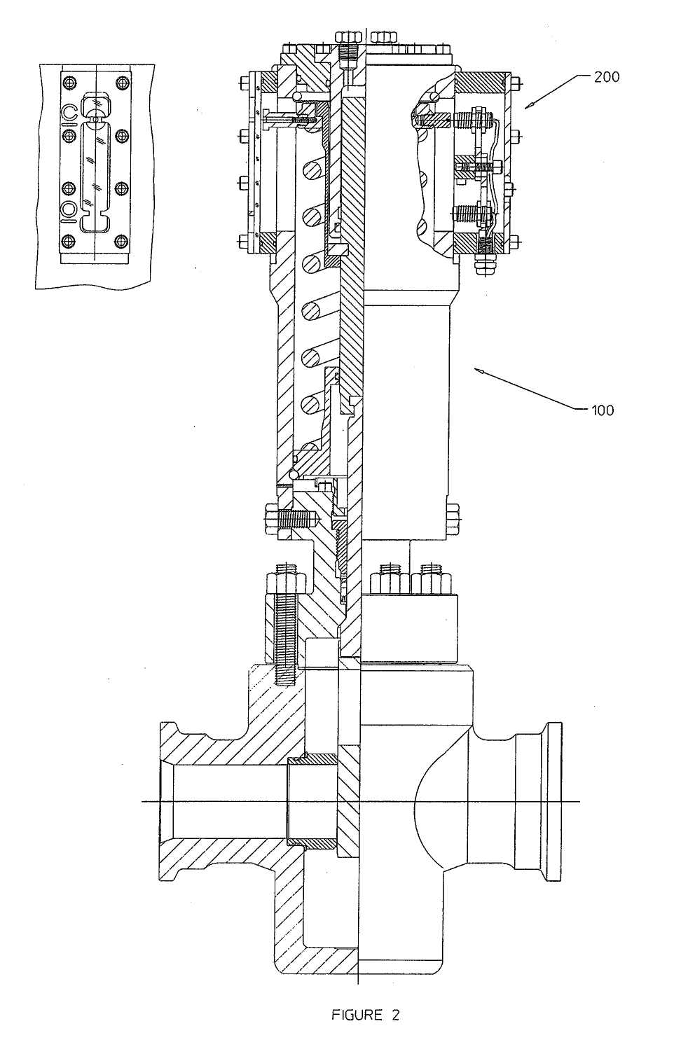

Referring now to FIG. 2, shown therein is another embodiment of the actuator 100 of FIG. 1. In addition to the features disclosed above with respect to FIG. 1, the actuator 100 of FIG. 2 includes an electronic position indicator 200, which is well known in the art.

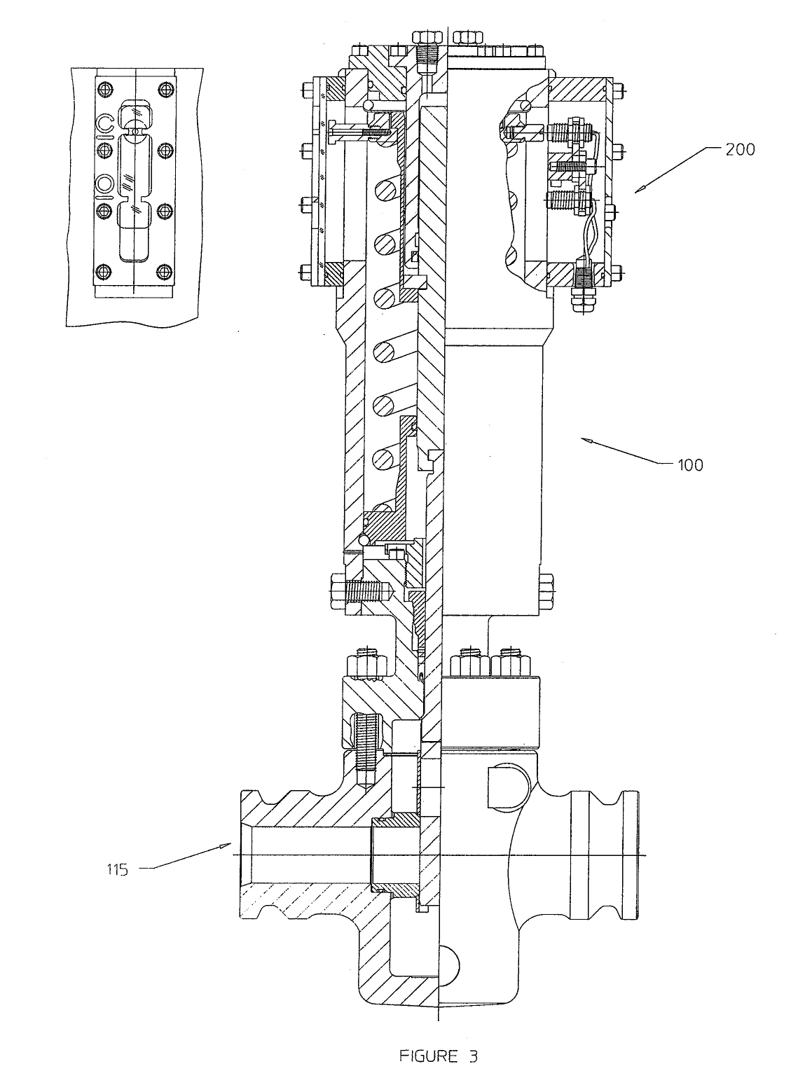

Referring now to FIG. 3, shown therein is another embodiment of the actuator 100 of FIGS. 1 and 2. The actuator 100 of FIG. 3 is similar to the actuator 100 of FIG. 2, with a major difference being the size of the various features. For example, but not by way of limitation, the flow line 115 of FIG. 3 may be smaller than the flow line 115 of FIG. 2. While size is not intended to be a limitation on any of the features, FIG. 3 illustrates how the various features may be modified to accommodate different conditions.

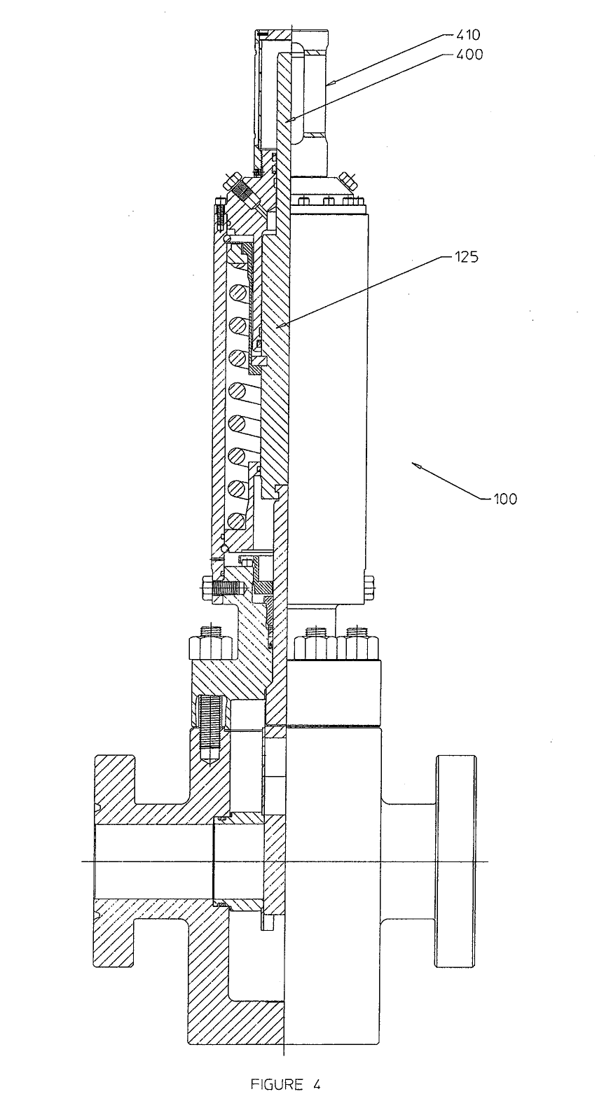

Referring now to FIG. 4, shown therein is yet another embodiment of the actuator 100 of FIGS. 1-3. The actuator 100 of FIG. 4 is similar to the actuator 100 of FIGS. 1-3, with a major difference being the addition of a rod 400 extending out of the end of the piston 125. The rod 400 may provide a visual position indication and allow a lock open cap (not shown) to be attached to the actuator 100 when the rod protector housing 410 is removed.

The actuator 100 of the present invention is desirably a hydraulic valve. However, it may also be operated manually, or pneumatically as conditions dictate. The actuator 100 may be applied to applications either onshore or offshore. Additionally, while a “fail-safe close” type valve is shown and described, the features of the present invention may also be used with minimal modification to a “fail-safe open” type valve.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. Also, the terms in the claims have their plain, ordinary meaning unless otherwise explicitly and clearly defined by the patentee.

What is claimed is:

1. A gate valve actuator comprising:
a housing;
a piston situated within the housing;
a lower end closure connecting the housing to the piston; and
a piston cylinder end cap connecting the housing to the piston,
wherein the connection between the lower end closure and the piston and the connection between the piston cylinder end cap and the piston are sealable connections,
wherein the housing, the piston, the lower end closure, and the piston cylinder end cap define a main actuator cavity, which is substantially isolated from ambient air and from a control fluid, and
wherein the main actuator cavity will remain at a substantially constant volume.

2. The gate valve actuator of claim 1, where the lower end closure and the piston cylinder end cap are substantially stationary relative to each other, and wherein the piston is capable of stroking along an axis parallel to an axis defined by the piston's connections to the lower end closure and the piston cylinder end cap.

3. The gate valve actuator of claim 1 wherein any section of the piston that is capable of stroking along a distance between the lower end closure and the piston cylinder end cap has a substantially uniform diameter.

4. The gate valve actuator of claim 2, wherein the connection between the lower end closure and the piston and the connection between the piston cylinder end cap and the piston are slidable sealable connections, so that a seal will be maintained at those connections when the piston strokes in slidable relation to the lower end closure and the piston cylinder cap.

5. The gate valve actuator of claim 1 wherein at least one of the sealable connections comprises a seal comprising a resilient material.

6. The gate valve actuation of claim 1 wherein at least one of the sealable connections comprises a seal comprising a spring energized thermoplastic.

7. The gate valve actuator of claim 1 further comprising a seal disposed in at least one connection selected from the group consisting of: the connection between the lower end closure and the housing, and the connection between the piston cylinder end cap and the housing.

8. The gate valve actuator of claim 2 further comprising a thrust ring situated in the main actuator cavity, wherein the thrust ring is affixed to a location on the piston that is disposed between the piston's connections to the lower end closure and the piston cylinder end cap, and wherein the thrust ring is loaded by a spring that is capable of exerting a force on the thrust ring in a direction that is substantially parallel with the axis along which the piston strokes.

9. The gate valve actuator of claim 2 wherein the piston is capable of stroking in at least one direction in response control fluid pressure.

10. The gate valve actuator of claim 1 further comprising a stem connected to the end of the piston at a point on the piston that is below the lower end closure.

11. A gate valve actuator comprising:
a housing;
a piston situated within the housing;
a lower end closure connecting the housing to the piston;
a piston cylinder end cap connecting the housing to the piston; and
a main actuator cavity defined by the housing, the piston, the lower end closure, and the piston cylinder end cap,
wherein the piston is capable of stroking along an axis parallel to the axis defined by the piston's connections to the lower end closure and the piston cylinder end cap,
wherein the connection between the lower end closure and the piston and the connection between the piston cylinder end cap and the piston are sealable connections,
wherein the main actuator cavity is substantially isolated from ambient air and from a control fluid, and
wherein the main actuator cavity will remain at a substantially constant volume as the piston strokes.

12. The gate valve actuator of claim 11, wherein the connection between the lower end closure and the piston and the connection between the piston cylinder end cap and the piston are slidable sealable connections, so that a seal will be maintained at those connections when the piston strokes in slidable relation to the lower end closure and the piston cylinder cap.

13. The gate valve actuator of claim 11, wherein the sealable connections each comprise a seal which comprises a material selected from the group consisting of: a resilient material and a spring energized thermoplastic.

14. The gate valve actuator of claim 11 further comprising a thrust ring situated in the main actuator cavity, wherein the thrust ring is affixed to a location on the piston that is disposed between the piston's connections to the lower end closure and the piston cylinder end cap, and wherein the thrust ring is loaded by a spring that is capable of exerting a force on the thrust ring in a direction that is substantially parallel with the axis along which the piston strokes.

15. The gate valve actuator of claim 11 wherein piston is capable of stroking in at least one direction in response to control fluid pressure.

16. The gate valve actuator of claim 11 wherein the housing comprises a sight glass, which allows the position of the piston to be observed from a point outside the housing.

17. A gate valve actuator comprising:
a housing;
a piston situated within the housing;
a lower end closure connecting the housing to the piston;
a piston cylinder end cap connecting the housing to the piston;
a main actuator cavity defined on all sides by the housing, the piston, the lower end closure, and the piston cylinder end cap;
a stem situated within the housing below the lower end closure, wherein the stem extends along the same axis as the piston, is connected to the lower terminus of the piston, and has a different diameter than the piston;
a downstop that connects the stem and a portion of the housing which is below the housing's connection to the lower end closure;
a bonnet connecting the housing to a valve body; and
an inner cavity defined by the lower end closure, the stem, the downstop, the housing, and the bonnet,
wherein the piston and the stem are capable of stroking along an axis parallel to the axis defined by the piston's connections to the lower end closure and the piston cylinder end cap,
wherein the connection between the lower end closure and the piston and the connection between the piston cylinder end cap and the piston are sealable connections,
wherein the main actuator cavity is substantially isolated from ambient air and from a control fluid,
wherein the main actuator cavity will remain at a substantially constant volume as the piston strokes, and
wherein the volume of the inner cavity will change as the piston strokes.

18. The gate valve actuator of claim 17, wherein the side of the inner cavity that is defined by the housing and the bonnet comprises a vent through which the inner cavity is vented to the ambient air.

19. The gate valve actuator of claim 17, wherein the downstop forms a barrier to further movement of the stem in the downward direction.

20. The gate valve actuator of claim 17, wherein the sealable connections each comprise a seal which comprises a material selected from the group consisting of: a resilient material and a spring energized thermoplastic.
